(19) United States
(12) Patent Application Publication
(10) Pub. No.: US 2010/0009633 A1
(43) Pub. Date: Jan. 14, 2010

(54) SECURITY ENCRYPTION FOR WIRELESS PERIPHERALS

(75) Inventors: Stuart O. Goldman, Scottsdale, AZ (US); Karl F. Rauscher, Emmaus, PA (US)

Correspondence Address: FAY SHARPE/LUCENT, 1228 Euclid Avenue, 5th Floor, The Halle Building, Cleveland, OH, 44115-1843, US

(73) Assignee: LUCENT TECHNOLOGIES, INC., Murray Hill, NJ (US)

(21) Appl. No.: 12/169,234

(22) Filed: Jul. 8, 2008

(51) Int. Cl. H04L 9/00; H04B 7/005; H04K 1/00

(52) U.S. Cl. 455/41.3; 713/153; 713/150; 380/270

(57) ABSTRACT

An apparatus is provided for securing data wirelessly transmitted between a wireless peripheral (20) and a computer (10) to which the wireless peripheral (20) is wirelessly connected. The apparatus includes: a first device (30) that is operatively connected to a first component, the first component being the wireless peripheral (20); and, a second device (32) that is operatively connected to a second component, the second component being the computer (10). Suitably, at least one of the devices is operative to encrypt data from one of the components to which it is operatively connected prior to the data being wirelessly transmitted to the other one of the components, and at least the other one of the devices is operative to decrypt the data wirelessly received at the other one of the components.

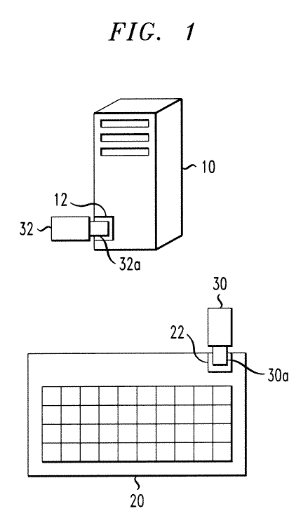

### FIELD

The present inventive subject matter relates to the wireless telecommunication arts. Particular application is found in conjunction with wireless peripherals for computers, and the specification makes particular reference thereto. However, it is to be appreciated that aspects of the present inventive subject matter are also amenable to other like applications and/or systems.

### BACKGROUND

Desktop, laptop and/or other like computers are largely ubiquitous in society. Generally, security can be a concern when such computers are used to store, access and/or transmit secret or otherwise sensitive data or information. Accordingly, for example, technology has been developed to encrypt the contents of a computer's hard drive or other like storage device as a security measure to protect the data thereon, e.g., if the computer should be stolen or accessed by an unauthorized individual or otherwise similarly compromised.

Encryption and/or similar security measures have also been developed to allow computers to safely access and/or transmit data over the Internet and/or other networks, e.g., such as a Wi-Fi network, an IEEE (Institute of Electrical and Electronics Engineers) 802.11x network, or another like wireless local area network (WLAN). For example, transport layer security (TLS), encrypted Secure Socket Layer (SSL), Hypertext Transfer Protocol over Secure Socket Layer (HTTPS) and the like are protocols and/or standards commonly employed to securely access and/or transmit data over the Internet. Similarly, WEP (Wired Equivalent Privacy), WAP (Wi-Fi Protected Access) and the like are commonly used to secure data transmitted over 802.11x, Wi-Fi and/or other like WLANs.

Notwithstanding the foregoing, there can remain a security weakness when a wireless peripheral (e.g., a wireless keyboard, a wireless mouse or other wireless pointing device, a wireless video monitor or other wireless or remote display device, etc.), is employed in connection with a computer. Commonly, such wireless peripherals employ infrared (IR), radio frequency (RF), Bluetooth or other like generally short range wireless transmission technologies to communicate and/or otherwise exchange data with the computer to which they are wirelessly connected. Often, data wirelessly exchanged and/or transmitted between the wireless peripheral and computer (e.g., such as keystrokes from a wireless keyboard) is vulnerable to eavesdropping or other like unauthorized interception. To make the problem even worse, often casual users are not even aware that this security weakness and/or risk exists.

Accordingly, a new and improved system and/or method for encrypting and/or otherwise securing data exchange between a wireless peripheral and a computer to which the wireless peripheral is wireless connected is disclosed that addresses the above-referenced problems and others.

### SUMMARY

In accordance with one embodiment, an apparatus is provided for securing data wirelessly transmitted between a wireless peripheral and a computer to which the wireless peripheral is wirelessly connected. The apparatus includes: a first device that is operatively connected to a first component, the first component being the wireless peripheral; and, a second device that is operatively connected to a second component, the second component being the computer. Suitably, at least one of the devices is operative to encrypt data from one of the components to which it is operatively connected prior to the data being wirelessly transmitted to the other one of the components, and at least the other one of the devices is operative to decrypt the data wirelessly received at the other one of the components.

In accordance with another embodiment, a method is provided for securing data wirelessly transmitted between a wireless peripheral and a computer to which the wireless peripheral is wirelessly connected. The method includes: operatively connecting a first device to a first component, the first component being the wireless peripheral; and, operatively connecting a second device to a second component, the second component being the computer. Suitably, at least one of the devices is operative to encrypt data from one of the components to which it is operatively connected prior to the data being wirelessly transmitted to the other one of the components, and at least the other one of the devices is operative to decrypt the data wirelessly received at the other one of the components.

In accordance with yet another embodiment, a method is provided for securing data wirelessly transmitted between a wireless peripheral and a computer to which the wireless peripheral is wirelessly connected. The method includes: generating data at a first component, the first component being one of the wireless peripheral or the computer; encrypting the generated data; wirelessly transmitting the encrypted data to a second component, the second component being the other of the wireless peripheral or the computer; receiving the wirelessly transmitted encrypted data at the second component; and, decrypting the received encrypted data.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter disclosed herein may take form in various components and arrangements of components, and in various steps and arrangements of steps. The drawings are only for purposes of illustrating preferred embodiments and are not to be construed as limiting. Further, it is to be appreciated that the drawings are not to scale.

The FIGURE is diagrammatic illustration showing a computer, wireless peripheral and mate pair of security devices suitable for practicing aspects of the present inventive subject matter.

### DETAILED DESCRIPTION OF PREFERRED EMBODIMENTS

For clarity and simplicity, the present specification shall refer to structural and/or functional elements, entities and/or facilities, relevant standards, protocols and/or services, and other components that are commonly known in the art without further detailed explanation as to their configuration or operation except to the extent they have been modified or altered in accordance with and/or to accommodate the preferred embodiment(s) presented herein.

Generally, the present specification discloses a method and/or apparatus or system for encrypting and/or otherwise securing data wirelessly exchanged or transmitted between a wireless peripheral (WP) (e.g., such as a wireless keyboard, a wireless mouse or other wireless pointing device, a wireless video monitor or other like wireless and/or remote display device, etc.) and a computer to which the wireless peripheral is wirelessly connected.

With specific reference now to the FIGURE, there is shown a computer 10. In this exemplary embodiment, the computer 10 is illustrated as a desktop computer. However, it is to be appreciated that in practice the computer 10 may also be a laptop computer or any other suitable type of computer. Also illustrated in the FIGURE, is a WP 20. In this exemplary embodiment, the WP 20 is illustrated as a wireless keyboard. However, it is to be appreciated that in practice the WP 20 may also be any other suitable type of WP, e.g., such as a wireless mouse or other wireless pointing device, a wireless video monitor or other like wireless and/or remote display device, etc. Suitably, the WP 20 and the computer 10 exchange data or otherwise operatively communicate with one another wirelessly, e.g., using a wireless connection or over-the-air interface such as IR, RF, Bluetooth, UWB (Ultra-wideband) or another similar relatively short-range wireless transmission/communication technology.

As shown in the FIGURE, a pair of mated or otherwise corresponding devices (i.e., electronic security keys, or cards or other like elements 30 and 32) are employed to secure data wirelessly exchanged and/or transmitted between the WP 20 and the computer 10 so as to guard against eavesdropping and/or other unauthorized interception. Suitably, the devices 30 and 32 operate to encrypt exchanged data before it is transmitted over the wireless interface between the WP 20 and the computer 10. Additionally, once the encrypted data has been received at the other end, the corresponding device 30 or 32 operates to decrypt the data. In particular, the devices 30 and 32 are optionally equipped and/or otherwise provisioned with mated or otherwise corresponding encryption and decryption algorithms or keys. Suitably, the encryption is applied by one of the devices 30 or 32 prior to being transmitted by the corresponding data sending element (i.e., one of the WP 20 or the computer 10) over the wireless interface to the opposing data receiving element (i.e., the other of the WP 20 or the computer 10) where the other one of the devices (i.e., 30 or 32) decrypts the data once it has been received. Optionally, both of the devices 30 and 32 are equipped and/or otherwise provisioned to selectively operated in both the encryption and decryption modes depending upon the direction of data flow over the wireless interface between the WP 20 and the computer 10.

For example, data representing a keystroke entered on the WP 20 is encrypted by the device 30 prior to being wirelessly transmitted to the computer 10. Thereafter, when the encrypted data is received by the computer 10, the device 32 decrypts the received data to thereby resolve the same so that the computer 10 is able to recognize the underlying data, e.g., as the entered keystroke. Significantly, however, eavesdroppers or other unauthorized individuals intercepting communications as they are wirelessly transmitted from the WP 20 to the computer 10 would only receive the encrypted data, and absent the appropriate decryption algorithm or key, they would accordingly be barred or hindered from obtaining or recognizing the underlying data. Likewise, the same suitably holds true for data transmitted from the computer 10 to the WP 20. However, in this case, the device 32 would act as the agent or element that encrypted the data prior to its wireless transmission, and the device 30 would act as the corresponding decryption agent or element on the data receiving end.

In one suitable embodiment, the devices 30 and/or 32 are implemented as USB (Universal Serial Bus) keys or flash drives or memory or smart cards or ICCs (Integrated Circuit Cards) or other like selectively removable devices programmed and/or otherwise provisioned, e.g., with suitable software or other like instructions, hardware, firmware, etc., for carrying out the aforementioned encryption and/or decryption as appropriate in a given circumstance.

For example, as shown in the FIGURE, the computer 10 and WP 20 are each equipped or otherwise provisioned with respective USB ports (i.e., 12 and 20) into which the devices 30 and 32 may be physical connected, e.g., via corresponding male USB connectors 30a and 32a, when their function is desired. Alternately, when their function is not desired, the devices 30 and/or 32 are free to be removed or otherwise physically disconnected from their respective components (i.e., the computer 10 and/or the WP 20). Alternately, the devices 30 and 32 are implemented as memory or smart cards or ICCs or the like and the computer 10 and WP 20 are equipped with respective card readers or the like into which the memory or smart cards, ICCs or other like devices can be selectively inserted and/or removed as desired. In this manner, regardless of which of the aforementioned implementations is actually employed, suitably, the mated or corresponding pair of devices 30 and 32 is free to be used with and/or switched between any combination of computer and WP as desired by a user.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. An apparatus for securing data wirelessly transmitted between a wireless peripheral and a computer to which the wireless peripheral is wirelessly connected, said apparatus comprising:
a first device that is operatively connected to a first component, said first component being the wireless peripheral; and,
a second device that is operatively connected to a second component, said second component being the computer;
wherein at least one of the devices is operative to encrypt data from one of the components to which it is operatively connected prior to the data being wirelessly transmitted to the other one of the components, and at least the other one of the devices is operative to decrypt the data wirelessly received at the other one of the components.

2. The apparatus of claim 1, wherein the wireless peripheral is selected from a group consisting of a wireless keyboard, a wireless pointing device, and a wireless display device.

3. The apparatus of claim 1, wherein at least one of the first and second devices is able to be selectively disconnected from its respective component.

4. The apparatus of claim 1, wherein at least one of the first and second devices is operatively connected to its respective component via a Universal Serial Bus (USB) port.

5. The apparatus of claim 4, wherein at least one of the first and second devices includes a male USB connector.

6. The apparatus of claim 1, wherein at least one of the first and second devices is implemented as one of a smart card, a memory card, or a integrated circuit card.

7. A method for securing data wirelessly transmitted between a wireless peripheral and a computer to which the wireless peripheral is wirelessly connected, said method comprising:
operatively connecting a first device to a first component, said first component being the wireless peripheral; and,
operatively connecting a second device to a second component, said second component being the computer;
wherein at least one of the devices is operative to encrypt data from one of the components to which it is operatively connected prior to the data being wirelessly transmitted to the other one of the components, and at least the other one of the devices is operative to decrypt the data wirelessly received at the other one of the components.

8. The method of claim 7, wherein the wireless peripheral is selected from a group consisting of a wireless keyboard, a wireless pointing device, and a wireless display device.

9. The method of claim 7, wherein at least one of the first and second devices is able to be selectively disconnected from its respective component.

10. The method of claim 7, wherein at least one of the first and second devices is operatively connected to its respective component via a Universal Serial Bus (USB) port.

11. The method of claim 10, wherein at least one of the first and second devices includes a male USB connector.

12. The method of claim 7, wherein at least one of the first and second devices is implemented as one of a smart card, a memory card, or a integrated circuit card.

13. A method for securing data wirelessly transmitted between a wireless peripheral and a computer to which the wireless peripheral is wirelessly connected, said method comprising:
(a) generating data at a first component, said first component being one of the wireless peripheral or the computer;
(b) encrypting the generated data;
(c) wirelessly transmitting the encrypted data to a second component, said second component being the other of the wireless peripheral or the computer;
(d) receiving the wirelessly transmitted encrypted data at the second component; and,
(e) decrypting the received encrypted data.

14. The method of claim 13, wherein step (b) is performed by a first device removably connected to the first component.

15. The method of claim 14, wherein step (e) is performed by a second device removably connected to the second component.

16. The method of claim 15, wherein at least one of the first and second devices is removably connected to its respective component via a Universal Serial Bus (USB) port.

17. The method of claim 13, wherein step (c) is carried out via one of an infrared, radio frequency, Bluetooth or ultra-wideband wireless communication interface.

18. The method of claim 13, wherein the wireless peripheral is selected from a group consisting of a wireless keyboard, a wireless pointing device, and a wireless display device.
